(19) United States
(12) Patent Application Publication
(10) Pub. No.: US 2022/0329710 A1
(43) Pub. Date: Oct. 13, 2022

(54) PRINT COVERAGE VECTORS

(71) Applicant: HEWLETT-PACKARD DEVELOPMENT COMPANY, L.P., Spring, TX (US)

(72) Inventors: Peter MOROVIC, Sant Cugat del Valles (ES); Jan MOROVIC, London (GB); Hector GOMEZ MINANO, Sant Cugat del Valles (ES)

(21) Appl. No.: 17/641,408

(22) PCT Filed: Sep. 26, 2019
(86) PCT No.: PCT/US2019/053288

§ 371 Date: Mar. 8, 2022

(51) Int. Cl. H04N 1/60

(52) U.S. Cl. CPC H04N 1/6058; H04N 1/6033

(57) ABSTRACT

In an example, a method includes determining, using processing circuitry, a first print coverage vector associated with an estimated colorimetry which corresponds to a target colorimetry, wherein the estimated colorimetry of the print coverage vector is based on a first color model, the first print coverage vector being optimised relative to a first metric. The method may further include determining, using processing circuitry, a predicted colorimetry of the first print coverage vector based on a second color model.

### BACKGROUND

Printing systems may convert input data (for example, data representing an image for two-dimensional printing, or data representing an object for three dimensional printing) to print instructions, which specify where print materials (for example, colorants such as inks or toners or other printable materials) are to be placed in a print operation.

### BRIEF DESCRIPTION OF DRAWINGS

For a more complete understanding, reference is now made to the following description taken in conjunction with the accompanying drawings in which:

FIGS. 1 and 2 are examples of methods for determining a print coverage vector;

FIG. 3 is an example of a method for developing color mapping resources;

FIG. 4 is an example of a method for determining a print coverage vector;

FIG. 5 is an example of apparatus comprising processing circuitry;

FIG. 6 is an example of a print apparatus; and

FIG. 7 is a block diagram of an example non-transitory machine readable medium associated with a processor.

### DETAILED DESCRIPTION

In the case of two-dimensional printing, a print addressable location may be represented by at least one pixel, and each print addressable location may be printed with at least one colorant such as inks (for example cyan, magenta, yellow and black inks), coatings or other print materials, as well as combinations of those print materials.

In the case of three-dimensional printing, which is also referred to as additive manufacturing, three-dimensional space may be characterised in terms of ‘voxels’, i.e. three-dimensional pixels, wherein each voxel occupies or represents a discrete volume. In examples of three-dimensional printing therefore, a print addressable area may correspond to at least one voxel and each voxel may be ‘printed’ i.e. generated or manufactured, using one or a combination of agents and/or build materials.

To briefly discuss three-dimensional printing in greater detail, objects generated by an additive manufacturing process may be formed in a layer-by-layer manner. In one example, an object is generated by solidifying portions of layers of build material. In examples, the build material may be in the form of a powder or powder-like material, a fluid or a sheet material. In some examples, the intended solidification and/or physical properties may be achieved by printing an agent onto a layer of the build material. Energy may be applied to the layer and the build material on which an agent has been applied may coalesce and solidify upon cooling. In other examples, directed energy may be used to selectively cause coalescence of build material, or chemical binding agents may be used to solidify a build material. In other examples, three-dimensional objects may be generated by using extruded plastics or sprayed materials as build materials, which solidify to form an object. The object may be colored during object generation, and/or may be colored in a post processing step.

In examples herein, possible print materials to be applied to a print addressable location are specified within an element set referred to as a print coverage vector. In some examples, the print materials may be identified explicitly, i.e. in a set of elements comprising a set of print materials and/or print material combinations. In other examples, it may be that at least one of the elements of an element set relates to another quality, which may in turn be related to print materials. For example, an element may specify a property or the like which can be mapped to print material(s). Therefore, the elements may describe print material(s) explicitly or implicitly, for example via a mapping.

In some examples, an element set may comprise a set of Neugebauer Primaries (NPs), wherein the NPs are the possible print materials and print material combinations that may be applied to a print addressable location, along with in some examples, an amount of print material, for example the number of drops of printing agent. The NPs may for example be associated with any or any combination of a particular print apparatus, or class of print apparatus, particular print materials, particular substrates or print media onto which print materials are to be applied, or the like.

Each element of a print coverage vector may be associated with a probability that that element will be selected for application to a print addressable location associated with the print coverage vector.

For example, a print addressable location within input data (e.g. a pixel in image data or a voxel in object model data) may be associated with a print coverage vector expressed using an element set. The element set may include elements which specify (directly or via a mapping) print materials and print material combinations which may be applied to the location, along with their amounts, each element being associated with a probability of being applied to that location. In the case of two-dimensional printing where the elements are NPs, these vectors may be referred to as area coverage vectors, Neugebauer Primary Area Coverage vectors (NPac vectors, or simply NPacs). In the case of three-dimensional printing, these may be referred to as volume coverage vectors, Material Volume coverage vectors (termed Mvoc vectors, or simply Mvocs, herein), which may also have NPs as elements.

As noted above, such element sets provide a probability that a print material or a combination of print materials may be applied in a location. In a simple case, an element set may indicate that the particular print material or print material combination should be applied to a location associated with such an element set on X% of occasions, whereas (100−X)% of occasions the location should be left clear of the print material. In practise, this may be resolved at the addressable resolution for the print material and/or printing device. Therefore, if there are N addressable locations in an XY plane associated with such an element set, around X% of these N locations may be expected to receive a print material, while around (100−X)% do not.

For example, in a printing system with two available print materials (for example, inks, coatings or agents), identified as M1 and M2, where each print material may be independently deposited in an addressable location (e.g. voxel or pixel) as a single drop, there may be 2² (i.e. four) elements with associated probabilities in a given Mvoc or NPac coverage vector: a first probability for M1 without M2; a second probability for M2 without M1; a third probability for an over-deposit (i.e. a combination) of M1 and M2, e.g. M2 deposited over M1 or vice versa; and a fourth probability for an absence of both M1 and M2 (indicated as Z herein). In this example, it is assumed that a drop of print material may be applied or not: i.e. a binary choice may be made and the value for each agent may be either 0 or 1. In other words, in this example, the NPs are M1, M2, M1M2 and Z.

In this case, a print coverage vector or element set may be: [M1:P1, M2:P2, M1M2:P3, Z:P4] or with example probabilities [M1:0.2, M2:0.2, M1M2:0.5, Z:0.1]—in a set of print addressable locations (e.g. an [x, y] or an [x, y, z] location (which in some examples may be a [x, y] location in a z slice)) to which the element set applies, and on average, 20% of locations are to receive M1 without M2, 20% are to receive M2 without M1, 50% of locations are to receive M1 and M2 and 10% are to be left clear (Z). In non-binary systems, there may be more elements defined describing the different amounts of print agent and/or associated combinations of print agents, which may be applied. As each value is a proportion and the set of values represent the available material combinations, the set of probability values in each element set generally sum to 1 or 100%.

More generally, for a binary (bi-level) printer, an NP is one of 2^{k} combinations of k print agents within the printing system, wherein print agents can be represented in single-drop states, in a k-dimensional color space. There may be more NPs for a greater number of drop states. For example, there may be kⁿ combinations for a set of n print agents have K drop states, which may define all of the possible print agent configuration states that a single pixel can receive, and therefore there may be up to kⁿ NPs in a vector. Where the probability associated with an NP is zero, then that NP may be (effectively or actually) absent from the vector/element set.

This may be compared to another example specification of print material amounts in which the area/volume coverage is controlled but the ‘at pixel’ or ‘at voxel’ choices are not (referred to as “print agent vectors” herein). For example, a print agent vector may specify that X% of a region receives agent M1 and Y% receives agent M2, but the overprinting of agents is not explicitly defined (although the sum of X and Y may be greater than 100, so overprinting may result).

Print coverage vectors may therefore specify a plurality of elements which are related to print materials, and a probability for each element. To generate a printed output, a selection may be made from the elements of a vector for each print addressable location, for example using halftoning.

Determining mappings from color space into the print coverage vectors can present a processing challenge: a full set of mappings may consume significant processing resources and large amounts of memory to store. Moreover, a color may be associated with more than one mapping. For example, two print coverage vectors may result in the same colorimetry but different print characteristics—for example, different levels of material use (one vector may use, on average, two drops per print addressable area while a second may result in application of, on average, 1.5 drops), image graininess or the like.

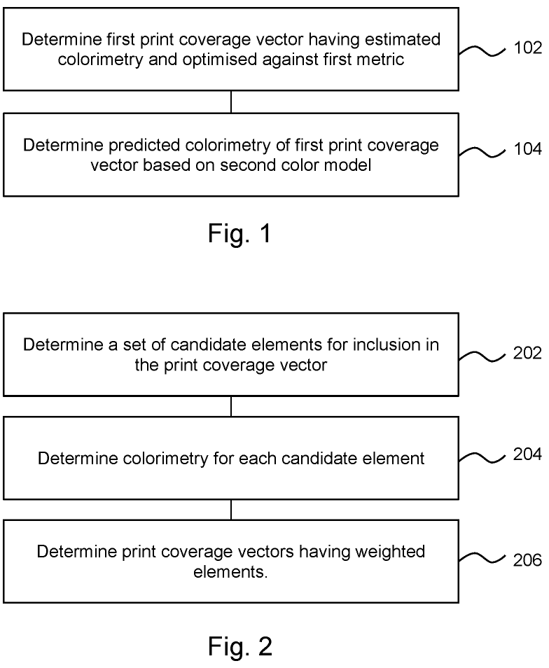

FIG. 1 is an example of a method, which may be a computer implemented method of determining a print coverage vector and an associated colorimetry for that vector. Such vectors may, for example, be included in mapping resources, such that, when the colorimetry associated with the vector is to be reproduced, the print coverage vector may be used to determine print instructions.

The method comprises, in block 102, determining, using processing circuitry, a first print coverage vector associated with an estimated colorimetry which corresponds to a target colorimetry, wherein the estimated colorimetry of the print coverage vector is based on a first color model, the first print coverage vector being optimised relative to a first metric.

In an example, as set out above, the print coverage vectors comprise elements representing possible print materials or combinations thereof for application to a particular print addressable area, where the elements are each associated with a probability. The elements may be NPs of a given intended printed system.

In an example, the first color model is a linear color model. In an example, the probabilities associated with elements may be used as weights for combining the colorimetries of each of the elements. The plurality of print coverage vectors include those made up of elements having associated weights/probabilities such that a weighted combination of the colorimetries of the elements corresponds to the target colorimetry. In some examples, the estimated colorimetry corresponds to the target colorimetry when it is equal thereto. In other examples, the estimated colorimetry corresponds to the target colorimetry when it is within a predetermined distance in color space of the target colorimetry.

The print coverage vector having an estimated colorimetry which corresponds to a target colorimetry and optimised against the first metric may be determined for example as an optimisation problem, for example a convex optimisation problem, as is discussed in greater detail below. In particular, the estimated colorimetry may be used as a constraint or condition in an optimisation relative to the first metric, allowing the first print coverage vector to be derived directly from an optimisation operation.

The target colorimetry may be expressed in any color space, and may in some examples be expressed in a color space which is independent of any print apparatus. For example, a device independent color space may be sRGB, Adobe RGB, or may be some other color space, for example a color space which uses an International Commission on Illumination (CIE) color model. Other color space models include Hue-Saturation-Value (HSV), Hue-Saturation-Lightness (HSL), Yule-Nielsen-corrected XYZ, XYZ, LAB or the like. In some examples, as is set out below, the target colorimetry may be one of a plurality of target colorimetries, or ‘anchor points’, which may in some examples be substantially evenly or uniformly distributed in the color space.

The first metric may comprise a print material amount metric (for example, an ‘ink use’ metric). This may for example identify the number of drops of ink to be applied on average if a vector is used. Optimising against this metric may comprise identifying the vector with the lowest ink use. This may for example allow print coverage vectors which result in low ink amounts to be selected to conserve resources. In other examples, other metrics may be used. Such metrics may for example comprise grain and/or robustness (i.e. repeatability/consistency). In some examples, a plurality of such metrics or print characteristics may be considered, in some examples with a priority order. The metric/characteristic(s) may for example be modelled or predicted, for example by simulating an image printed using the print coverage vector. This may comprise subjecting a vector to a halftoning process and generating a simulation of a printed result, which may also include a modelling of any perturbation which may result in real printing. In other examples, the characteristic(s) may be determined based on test data from printed (in some example, previously printed) samples produced using the print agents in the proportions set out in the print coverage vector. In some examples, the metric may be a metric which behaves in a linear manner (such as an ink use metric).

Determining an optimised metric may comprise determining the print coverage vector with an estimated colorimetry which matches the target colorimetry, and which provides the minimum or maximum performance relative to the first metric (e.g. the greatest or least ink use amounts). In one example, discussed in greater detail below, a second print coverage vector may also be determined based on the evaluation. This may comprise the vector which provides the opposite extreme against the metric to the first print coverage vector.

Where the metric characteristic is a metric/print characteristic which exhibits linear behaviour in relation to the print coverage vector (and, in the case of ink use, also in relation to a printed output), the vectors which correspond to the extremes of behaviour may be used to interpolate vectors which provide intermediate behaviour by a relatively simple weighted combination thereof. However, it is possible to interpolate between extremes even if they are not linearly behaved, so long as the non-linearity is characterised. For example, optimizing for a metric of grain or robustness rather than ink use means that trivial linear objective functions may not sufficiently model behaviour. In such cases, a 50/50 convex combination of the minimum and maximum vectors may not be a mid-point in terms of the property (e.g. may not be a mid-point in terms of grain or robustness, and therefore intermediate combinations may be explicitly evaluated (for example, simulated or printed, then analysed to determine their attributes) to better characterise the functions.

It may be noted that any metric that may be formulated as a linear function of a print material coverage vectors such as NPacs (for example, ink-use, or some other prioritization/penalization of NPs used by an NPac) can be optimised by Linear Programming. For linear metrics, linear programing provides a computationally and resource efficient tool to compute optimal vectors such as NPacs (which may otherwise be identified by analysing a high number of printed samples). Moreover, when the constraints are convex (which is true in case of the convex weights for NPs), convex objective functions may be used to optimise a metric (of which linear functions used in linear programing are the simplest case).

Block 104 comprises determining, using processing circuitry, a predicted colorimetry of the first print coverage vector based on a second color model. The second color model may be a more accurate model than the first color model. For example, the second color model may be based on theories such as the Kubelka-Munk theory of ink-mixing and/or the Yule-Nielsen theory of optical and physical dot-gain, coupled with a data-fitting approach, such as described in “Spectral and color prediction for arbitrary halftone patterns: a drop-by-drop, WYSIWYG, “ink on display” print preview”, by Morovič, P, Morovič, J., Fariña, X., Gasparin, P., Encrenaz, M., Arnabat, J., in Proceedings of 23rd IS&T/SID Color and Imaging Conference, Darmstadt, Germany, November 2015. For example, the second color model may be based on an initial estimate of the colorimetry of all ink-combinations (using Kubelka-Munk) involved in a given print coverage vector. A coverage-weighted average of the colorimetries in a non-linear (Yule-Nielsen) compensated domain may be calculated to get to a first estimate of colorimetry, followed by a data-fitting mapping that results in a second, accurate estimate of colorimetry.

It may be noted that the predicted colorimetry may differ from the target colorimetry (although it will likely be in the approximate neighborhood of the target colorimetry, and may be fairly close thereto, in particular if the NP colorimetries are not too sparsely distributed in color space). The resulting relationship between a first print coverage vector (which is selected to perform in an intended way against a metric) and the predicted colorimetry (which may be more accurate than the estimated colorimetry) may form an entry in a mapping resource, mapping from color space to print coverage vector space.

The first color model may be a relatively simple model, for example based on linear combinations of elements weighted according to their probabilities. As is discussed in greater detail below, the colorimetry of the elements themselves may be determined previously, for example using printed samples or complex color models. While this may give a reasonable approximation of color, print materials can behave in a non-linear way, for example due to interactions between the materials, or between the materials and the substrate. However, such linear combinations may allow candidate print coverage vectors which are likely to correspond to a particular region in color space to be identified relatively easily. This is the case even though the first color model is known to be inaccurate. The print coverage vectors which are derived to perform as intended against a metric such as ink use may be subjected to a more complex model, which may reflect the non-linear behaviour. However, as this is not carried out for all candidate vectors, the processing resources are not unduly consumed.

The method of FIG. 1 therefore may provide an efficient method for generating a print coverage vector which performs well against a metric such as ink use based on the first color model, and which may (approximately) lie in an intended region in color space, i.e. a region which is close to the target colorimetry. These vectors may be accurately placed in color space using the second color model.

FIG. 2 is an example of a method of carrying out block 102.

In block 202, a set of candidate elements for inclusion in the print coverage vector is determined. Each element specifies a print material or print material combination to be applied to a print addressable area. For example, this may be the set of NPs, and in some examples is up to the full set of NPs for an intended printing system and/or printing parameters.

Block 204 comprises determining a colorimetry for each of the candidate elements. In other words, the colorimetry of each of elements (for example, each of the NPs), is determined individually. The colorimetry of each of the elements may be computed using an accurate color model, for example, using Kubelka-Munk and Yule-Nielsen as mentioned above. Such models may allow elements to be associated with their colorimetry, even where the individual elements may be, for example, unprintable as a sample as they exceed an upper ink usage threshold or the like. This may for example be determined in the same color space as is used to characterise the target color. This colorimetry may for example be predetermined, for example being held in a memory or the like, and determining the colorimetry may comprise retrieving it from a memory or the like.

Block 206 comprises determining a print coverage vector having the target colorimetry which is minimised relative to ink use.

In practice, block 206 is carried out by determining a solution to an optimisation problem having the condition that the estimated colorimetry matches the target colorimetry. To consider this in greater detail, an NPac may be expressed as:

[NP(1):p1, NP(2):p2 . . . NP(N):pN], where the different elements correspond to different NPs and each NP(i) has an associated probability pi (which in this example is between, or equal to, 0 and 1).

According to a linear color model, the colorimetry of the NPac may be expressed as:

Σᵢ₌₁^{i=N}(C(NP(i))*pi), where C(NP(i)) is the colorimetry of NP(i).

In other words, pi acts as a weight when determining the contribution of colorimetry of NP(i) to the colorimetry of the NPac.

The plurality of print coverage vectors corresponding to the target colorimetry may be determined as an optimisation problem having the following condition:

Σᵢ₌₁^{i=N}(C(NP(i))*pi)=Target colorimetry

If the target colorimetry is associated with a tolerance or range (e.g. is a partition or ‘bin’ in color space), this set may be larger than if a single target colorimetry value is considered. Such bins or partitions may be specified in terms of color difference, For example, the partitions may be characterised by a ΔC amount in an XYZ, LAB or RGB color space or a ΔE value in an International Commission on Illumination (CIE) color model space. In some examples, the color space used is a Yule-Nielsen modified CIE XYZ, a CIE XYZ or CIE LAB. In some examples, a color space which corresponds well to linear/convex combination assumptions may be used. While a ΔE value may be used, this may be relatively complex, for example involving computation of convex hull of a sphere defined in LAB, converting the extreme vertices thereof to an optimization space (e.g. to XYZ), recomputing the convex hull and using this as an inequality constraint.

The optimisation may be subject to additional conditions, and in this example, a condition may be:

Σᵢ₌₁^{i=N}(pi)=1

This means that the probabilities/weights are convex weights, and the optimisation problem is a convex optimisation problem.

Another condition may be that, for all i, 0≤pi≤1.

Another condition may be that the print coverage vectors are within predetermined print material amount thresholds. For example, there may be an upper threshold to the amount of print agent that can be applied in printing. The print material amount associated with the print coverage vector may be determined as:

Σᵢ₌₁^{i=N}(pi*Vol(NP(i))), where Vol(NP(i)) is the amount of print material specified by NP(i). For example, this may comprise a number of ink drops, and/or a specification of ink drop size and/or a specification of ink drop weight.

In some examples, an associated condition which may be used in the optimisation problem is:

Σᵢ₌₁^{i=N}pi*Vol(NP(i))≤Vol_limit, where Vol_limit is the upper threshold to the amount of print agent that is to be applied in printing, for example for a given printing system, print material and/or print media.

Therefore, in examples, the method of block 102 may be carried out by solving an optimisation problem given the following condition:

Σᵢ₌₁^{i=N}C(NP(i))*pi=Target colorimetry (1)

In some examples, further conditions may include any or any combination of:

Σᵢ₌₁^{i=N}pi=1 (2)

0≤pi≤1 (3)

Σᵢ₌₁^{i=N}pi*Vol(NP(i))≤Vol_limit (4)

The optimisation problem (in this case, minimising print agent use) may be stated as:

Minimize Σᵢ₌₁^{i=N}pi*Vol(NP(i)) subject to the applicable conditions.

This process is relatively computationally efficient when compared to tessellation based techniques, and scales well with the number of elements (e.g. NPs). In addition, the method is deterministic and repeatable, as it does not rely on random sampling, unlike other techniques for identifying a suitable vector, instead deriving the vector directly as a solution to an optimization problem subject to at least a condition in relation to estimated colorimetry, wherein the estimate of colorimetry is computed in this example using a simple linear combination.

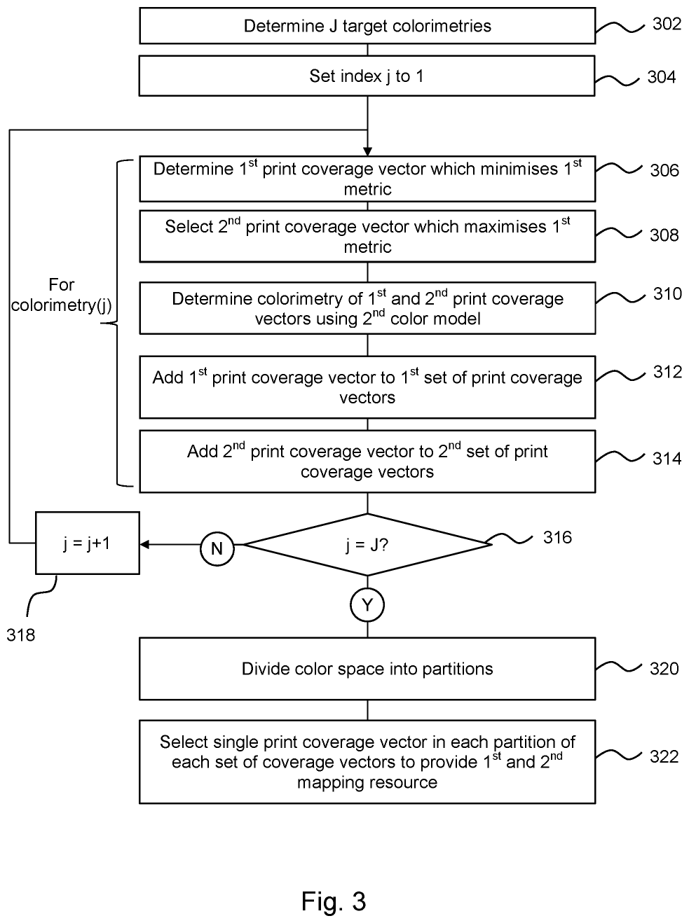

FIG. 3 is an example of a method for defining a first and a second mapping resource. The first mapping resource maps between a color space and a set of print coverage vectors which result in a metric (in this example, ink use) being minimised, and a second mapping resource maps between a color space and a set of print coverage vectors which result in the metric being maximised. It may be noted that such “maximised” vectors may be determined as being a solution to the problem:

Minimize −Σᵢ₌₁^{i=N}pi*Vol(NP(i)) subject to the condition(s).

Block 302 comprises determining a plurality of target colorimetries which, in this example are evenly distributed in a subspace of a color space. For example, this may comprise a ‘grid’ of N by N values, which may for example be uniform in LAB. The subspace may be a subspace of the color gamut of the printing system under consideration, i.e. a regular sampling of the color space as described by the convex hull of the NP colorimetries, and is a subspace of the color space of the method (for example, a XYZ, XYZ Yule-Nielsen or LAB color space).

Block 304 comprises setting an index j to 1, wherein there are J target colorimetries. In block 306, a first print coverage vector which minimises the metric is determined and block 308, a second print coverage vector which maximises the metric is determined, with the condition that the first and second print coverage vectors have estimated colorimetries which match the target colorimetry. The colorimetry of the first and second print coverage vectors is determined using the second color model in block 310. It may be noted that, while the target colorimetries were uniformly distributed, due to the differences between the color models, the determined colorimetries at this stage may not be uniformly distributed and the colorimetries of the first and second vectors, although likely to be similar, may be different from one another according to the second color model.

The first print coverage vector is added to a first set of print coverage vectors in block 312 and the second print coverage vector is added to a second set of print coverage vectors in block 314.

It is determined in block 316 if j is equal to J (which indicates that all target colorimetries have been assessed). If not, index j is incremented (block 318) and the method loops back to block 306. If however j is equal to J, then the method proceeds to block 320.

In block 320, a color space is divided into partitions. For example, this may be specified in terms of color difference, such that, for example, greens with a first hue range are in a first partition and greens with a second hue range are in a second partition. For example, the partitions may be characterised by a ΔC amount in an XYZ, XYZ Yule-Nielsen or LAB color space or a ΔE value in a CIE color model space, on the basis of the principles set out above. In some examples, all the partitions may be of the same size and the size of the partitions may be determined based on the amount of granular control intended for a color mapping resource, with smaller partitions allowing more precise control of colors via the color mapping resource(s) being developed in the method. In some examples, the available processing resources may be considered as more partitions will generally suggest greater use of processing resources such as processing time, power and storage capacity. In some examples, different partitions may be determined for each set of coverage vectors.

Then, in block 322, a single print coverage vector in each set of coverage vectors which fall, or lie, within a particular partition is selected for that partition (assuming that there is more than one vector corresponding to a partition). In this example, this is assessed relative to the metric, such that the single first print coverage vector in a partition which minimises the metric is selected for a modified first set, and the single second print coverage vector in a partition which maximises the metric is selected for a modified second set. In other examples, the selection may be made in some other way, for example randomly, or based on the colorimetry or the like. This may restore uniformity to the colorimetry of the set and/or provide a suitable sampling of the color space.

The modified first set of first print coverage vectors and the associated colorimetries therefore may provide a first mapping resource which minimises the metric (ink use) and the modified second set of second print coverage vectors and the associated colorimetries therefore may provide a second mapping resource which maximises the metric.

In some examples, for a given colorimetry, an interpolation may be made based on the first and second resources to determine a vector which is intermediate in terms of the metric (in particular if the metric behaves at least substantially in a linear manner). This may allow for control of the metric in printing. For example, for a given color or color partition, the vector which maximises the metric and the vector which minimises the metric could be combined in a weighted combination, wherein the weights relate to the intended performance against the metric. Where the metric is a linear metric, this may be a linear weighted combination, for example 50% of Vector_min+50% of Vector_max to produce a vector which performs at a mid-point relative to the metric. In some examples, this may also allow for balancing between different criteria, where a first metric is one of the criteria under consideration.

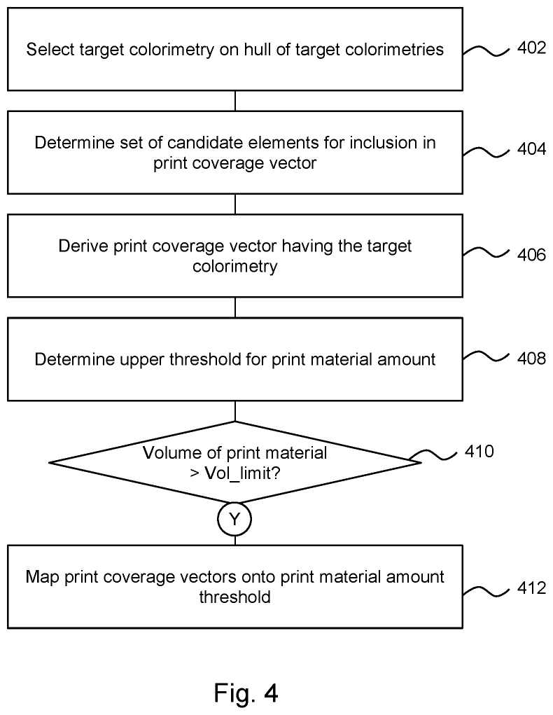

FIG. 4 shows an example which may be used in conjunction with the methods of FIGS. 1, 2 and/or 3, and which may provide entries for a mapping resource lying on the surface of the accessible gamut. These entries may be combined with the vectors determined using the method set out above to define a mapping resource that addresses the whole of the accessible gamut and wherever possible performs well against a metric such as ink use.

Block 402 comprises selecting a target colorimetry on the hull of the gamut of target colorimetries. The ‘hull’ or surface of a gamut may be defined using the most extreme defined colorimetries in any axis.

Block 404 comprises determining a set of candidate elements for inclusion in the print coverage vector, each element specifying a print material or print material combination to be applied to a print addressable area. This may for example comprise identifying the NPs of an intended printing system/arrangement, and setting these NPs as the candidate elements.

Block 406 comprises deriving at least one print coverage vector having an estimated colorimetry corresponding to the target colorimetry by determining at least one tessellation of the elements. The tessellation may for example comprise a linear tessellation such as a Delaunay tessellation. It may be noted that the number of polytopes involved in such a tessellation may be relatively constrained (as it only relates to the surface of the gamut), and therefore a tessellation may be efficiently processed.

Briefly, forming a tessellation may comprise linking the colorimetry of elements (e.g. NPs) in color space, for example forming polyhedrons (or polygons in 2D). The vertices of a polyhedron which enclose the target colorimetry are used as the elements of the print coverage vector, with probabilities or weights determined using the relative distance of the target colorimetry from the NP. Thus, a selected element which is relatively distant from the target colorimetry will have a lower weighting than one which is relatively close. The weights computed may be referred to as the barycentric coordinates of the vector. In some examples, the weighting is a linear weighting, and a linear color model may be used in combining the colors of the elements (e.g. NPs), as has been discussed above.

Block 408 comprises determining an upper threshold for a print material amount. For example, this may be the upper threshold to the amount of print agent that can be applied in printing, for example, Vol_limit as described above.

In block 410 it is determined whether the volume of print material specified by the print coverage vector derived in block 406 is above Vol_limit. The volume of print material may for example be determined as Σᵢ₌₁^{i=N}pi*Vol(NP(i)), for a vector with N elements with index i, as was discussed above.

This may be expected as the target colorimetries are at the extremes of the gamut and therefore may include vibrant colors and/or darker colors which are associated with a relatively high amount of print material.

If the determination is that the volume of print material specified by the print coverage vector is at most Vol_limit, then the print coverage vector may be selected for a mapping resource (or for an initial set which may be subject to further review, for example pruning those which do not lie on the convex hull, or another determined alpha hull, of the gamut). In some examples, a second color model (for example, a non-linear color model) may be applied to determine a more accurate colorimetry as described in relation to block 108 before the vector is included in a mapping resource and/or included in a set of vectors to be subjected to further partitioning.

If however the determination is that the volume of print material specified by the print coverage vector is above Vol_limit, the method continues to block 412 which comprises mapping print coverage vectors onto the threshold.

In one example, the procedure for target colorimetries on the hull of the gamut associated with print coverage vectors determined by tessellation which specify material amounts above Vol_limit is to re-compute the print coverage vectors for these target colorimetries as an optimisation problem. While the above optimisation was a linear optimisation, in this case, the optimisation may be a quadratic problem.

In this example, a subset of the elements may be used—specifically the subset which are associated with colorimetries on the hull of the element color gamut (for example, the ‘most colorful’ NPs). Conditions (2), (3) as set out above may be applied, and the total print material amount is set at the maximum (i.e. the weights/probabilities are between 0 and 1 and sum to 1 and the material amount equals Vol_limit).

For each hull target colorimetry, an optimisation may be performed on that set of vectors to find the vector closest to the hull target colorimetry (wherein the colorimetry of the vector is determined using a linear combination of the colorimetry of its elements (e.g. NPs) for this purpose). The distance may be a Euclidean distance. For this vector, a convex combination of the subset of elements which are included in the vector may be determined, subjecting the vector to the condition that the print material amount is at most Vol_limit (and in some examples, is equal to Vol_limit).

The problem may be expressed as, for an out-of-ink-limit vector No, find vector Ni (which includes all the elements i=1 to n) that will be on the ink-limit convex hull (Ni=pi*NPi) such that pj*NPi−No is minimized (where bold type and underlining is used to indicate a vector). If this is expanded, it may be seen that it has a quadratic form, indicative of the Euclidean distance in vector space (and therefore in as many dimensions as there are elements) between the beyond-maximum-amount threshold vector and the closest point on the convex hull.

In other words, this finds the convex weights pi (combining any available elements) that provide a vector as close to the original vector as possible but on the amount threshold.

In other words, in this example, while print coverage vectors corresponding to the interior of the gamut may be optimised against a metric such as ink use, the vectors which lie on the hull are not optimised in the same way. Instead, a vector is based on its Euclidean distance from the hull as determined using a linear model and mapped to a print material use hull It may be noted that this method avoids computing a print material use hull in vector space (which may have a high number of dimensions, for example equal to the number of elements/NPs) and instead allows the hull to be sampled.

It may be noted that, in other examples, an analytical or geometric technique may be used to map to the amount threshold instead of the quadratic minimisation problem approach used above.

In some examples, a metric such as ink use may also be optimised for the hull, or amount threshold, vectors. For example, a quadratic form of Quadratic Programing which includes a linear element may be used. For example, this may comprise minimizing an expression of the form xH′Hx+fx (where H′H is the quadratic matrix obtained by expanding the above described Euclidean distance minimization and f may comprise the amount of ink used by each NP).

Once a vector which respects the condition that the print material amount is at most Vol_limit is found then the print coverage vector may be selected for a mapping resource. In some examples, a second color model (for example, a non-linear color model) may be applied to determine a more accurate colorimetry as described in relation to block 108 before the vector is included in mapping resource and/or included in a set of vectors to be subjected to further partitioning.

The method of FIG. 4 may provide a sampling of vectors with colorimetries which lie on the gamut hull (which may be a convex hull), which may be relatively dense and may improve the colorfulness of mappings into print coverage vector space, resulting in a larger gamut of printed colors being available.

In some examples, the method of FIG. 4 may be carried out for each of a plurality of hull target colorimetries, and the identified vectors may be assessed to identify those which contribute to a hull of a gamut of the identified vectors. Vectors which do not lie on the hull of the gamut may be removed, as these may not contribute to the colourfulness of the mappings.

In some examples, images may be printed using the mapping resource(s) to determine print instructions, for example by selecting elements therefrom for print addressable locations based on a halftoning process or the like, and applying the print materials or print material combinations of the selected elements to the print addressable locations.

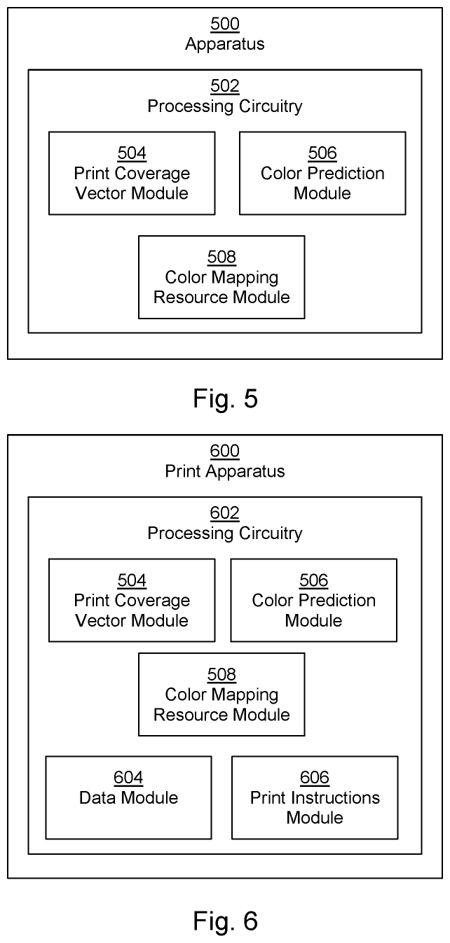

FIG. 5 is an example apparatus 500 comprising processing circuitry 502 comprising a print coverage vector module 504, a color prediction module 506, and a color mapping resource module 508.

In use of the apparatus 500, the print coverage vector module 504 determines a set of print coverage vectors, each of the print coverage vectors being determined to optimise a print characteristic, wherein the optimisation is subject to the condition that an estimated colorimetry of each print coverage vector corresponds to a respective target colorimetry of a predetermined set of target colorimetries, wherein the estimated colorimetry is determined using a first color model. For example this may use techniques described in relation to block 102, FIG. 2 and/or FIG. 3.

The metric may for example comprise ink use or graininess. In some examples, the metric/print characteristic is a metric/print characteristic which exhibits linear behaviour. For example this may use techniques described in relation to block 102.

In use of the apparatus 500, the color prediction module 506 determines a predicted colorimetry of print coverage vector(s) based on a second color model. For example, this may use techniques described in relation to block 104.

In use of the apparatus 500, the color mapping resource module 508 determines a color mapping resource for a print apparatus based on the determined print coverage vectors and the predicted colorimetry determined by the color prediction module 506. The color mapping resource may map each colorimetry to the corresponding vector. For example this may use techniques described in relation to FIG. 3.

FIG. 6 shows an example of a print apparatus 600 comprising processing circuitry 602. The processing circuitry 602 comprises, in addition to the print coverage vector module 504, color prediction module 506, and color mapping resource module 508 described above, a data module 604 and a print instructions module 606.

The data module 604, in use of the print apparatus 600, acquires data representing an article to be printed. The article may for example comprise a substantially two dimensional image, for example a picture, pattern or text to be applied to a substrate such as paper, card or plastic. In other examples, the article may comprise an object to be printed using additive manufacturing techniques. The data may for example include a color description.

The print instruction module 606, in use of the print apparatus 600, determines print instructions based on the acquired data and using the color mapping resource. For example, it may map between a color description and an element set (e.g. an NPac/Mvoc). The print instruction module 606 may further use techniques such as halftoning to select an element of the vector set to apply to the print addressable location. In other words, exactly one element of a vector may be selected for each print addressable location, and the associated print material or print material combination may be applied to the print addressable location (and no other print material).

The print apparatus 600, in use, prints an article according to print instructions. This may be a two dimensional or three dimensional article. To that end, the print apparatus 600 may comprise additional print apparatus components such as a print head, a print agent supply, and the like. Where the print apparatus 600 is a ‘two dimensional’ printer, it may comprise a laser printer or an inkjet printer or the like, and may comprise any or any combination of a print head, substrate handling system, a source of ink or toner, and the like. Where the print apparatus 600 is a ‘three dimensional’ printer, it may comprise, or be associated with any or any combination of a print bed, a fabrication chamber, a print head, an energy source, a source of build material, or the like.

In some examples, the processing circuitry 502, 602 may carry out at least one of the blocks of any of FIGS. 1 to 4.

The processing circuitry 502, 602, print coverage vector module 504, color prediction module 506, color mapping resource module 508, data module 604 and/or print instructions module 606 may be implemented with one or a plurality of processors executing machine readable instructions stored in a memory, or a processor operating in accordance with instructions embedded in logic circuitry. It is noted that in at least one example described herein, the term “module” refers to a hardware component of the apparatus.

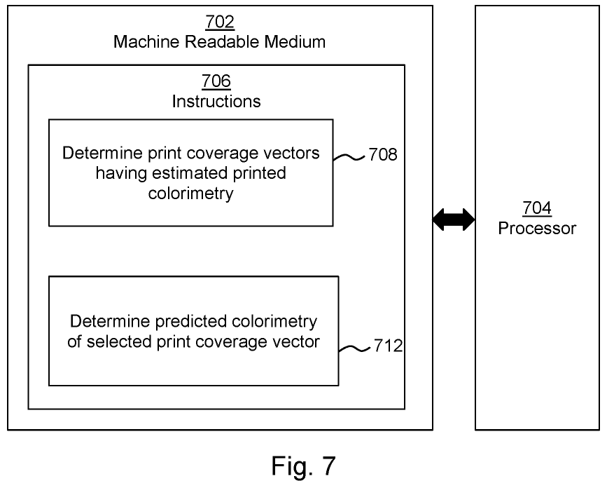

FIG. 7 shows an example of a non-transitory, tangible, machine readable medium 702 in association with a processor 704. The machine readable medium 702 has instructions 706 stored thereon. The instructions 706 when executed by the processor 704 cause the processor 704 to perform processing operations. The instructions 706 comprise instructions 708 to cause the processor 704 to determine a print coverage vector as a solution to an optimisation problem having a condition that print coverage vectors have an estimated colorimetry that matches a target colorimetry, The vector is determined using a linear color prediction model which determines an estimated colorimetry for a print coverage vector based on a weighted combination of the colorimetry of elements of the print coverage vector, wherein the weighting for each is a probability that the element is to be applied to a print addressable location.

The instructions 706 further comprise instructions 712 to cause the processor 704 to determine a predicted printed colorimetry of the print coverage vector based on a non-linear color prediction model. This may be a more accurate model than the linear color prediction model.

In some examples, the instructions 706 may, when executed by the processor 704 cause the processor 704 to carry out at least one of the blocks of any of FIGS. 1-4.

Examples in the present disclosure can be provided as methods, systems or as a combination of machine readable instructions and processing circuitry. Such machine readable instructions may be included on a non-transitory machine (for example, computer) readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing circuitry, or a module thereof, may execute the machine readable instructions. Thus functional modules of the processing circuitry 502, 602 (for example, the print coverage vector module 504, color prediction module 506, color mapping resource module 508, data module 604 and/or print instructions module 606) and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
determining, using processing circuitry, a first print coverage vector associated with an estimated colorimetry which corresponds to a target colorimetry, wherein the estimated colorimetry of the print coverage vector is based on a first color model, the first print coverage vector being optimised relative to a first metric; and
determining, using processing circuitry, a predicted colorimetry of the first print coverage vector based on a second color model.

2. A method according to claim 1 wherein the first color model is a linear color model and the second color model is a non-linear color model.

3. A method according to claim 1 wherein the method is repeated for each of a plurality of target colorimetries in color space, the method further comprising:
determining, using processing circuitry, a mapping resource associating the determined predicted colorimetries of the print coverage vectors with the vectors.

4. A method according to claim 3 wherein the plurality of target colorimetries are evenly distributed.

5. A method according to claim 3 further comprising:
determining, using processing circuitry, a plurality of partitions within color space, and
when a plurality of print coverage vectors fall within a partition, selecting, using processing circuitry, a print coverage vector for that partition.

6. A method according to claim 1 wherein the print coverage vector comprises a set of candidate elements for inclusion in a print coverage vector, each element specifying a print material or print material combination to be applied to a print addressable area, each of the candidate elements having a predetermined colorimetry;
the print coverage vector having weighted elements, wherein a weighted combination of the colorimetry of the elements results in the target colorimetry; and
wherein the weights are associated with the candidate elements as probabilities that the print material specified by the element will be applied to a print addressable area.

7. A method according to claim 6 wherein the optimisation is subject to a condition that the weights of the weighted elements of the print coverage vector sum to 1.

8. A method according to claim 6 wherein the optimisation is subject to a condition that the print coverage vector is within a predetermined print material amount threshold.

9. A method according to claim 1 wherein the first metric comprises a print material amount metric.

10. A method according to claim 1, wherein determining the first print coverage vector comprises determining the print coverage vector having the target colorimetry which minimises the first metric, and wherein the method further comprises:
selecting a second print coverage vector having the target colorimetry which maximises the first metric; and
determining a predicted colorimetry of the second print coverage vector based on the second color model.

11. A method according to claim 1 comprising
determining a target colorimetry on a hull of a gamut of target colorimetries, the method further comprising:
determining a set of candidate elements for inclusion in a third print coverage vector, each element specifying a print material or print material combination to be applied to a print addressable area;
identifying the print coverage vector having the target colorimetry by determining a tessellation of the elements;
determining an upper threshold for a print material amount; and
if the third print coverage vector exceeds the upper threshold, determining the closest print coverage vector in vector space which is at the threshold.

12. Apparatus comprising processing circuitry, the processing circuitry comprising:
a print coverage vector module to determine a set of print coverage vectors, each of the print coverage vectors being determined to optimise a print characteristic, wherein the optimisation is subject to a condition that an estimated colorimetry of each print coverage vector corresponds to a respective target colorimetry of a predetermined set of target colorimetries, wherein the estimated colorimetry is determined using a first color model;
a color prediction module to determine a predicted colorimetry of each print coverage vector of the set of print coverage vectors based on a second color model; and
a color mapping resource module to determine a color mapping resource for a print apparatus based on the set of print coverage vectors and the predicted colorimetry each print coverage vector.

13. Apparatus according to claim 12 further comprising:
a data module to acquire data representing an article to be printed; and
a print instruction module to determine print instructions based on the acquired data and using the color mapping resource.

14. Apparatus according to claim 13 further comprising print apparatus to print an article according to the print instructions.

15. A machine readable medium comprising instructions which, when executed by a processor, cause the processor to:
determine a print coverage vector as a solution to an optimisation problem having a condition that the print coverage vector has an estimated colorimetry that matches a target colorimetry and is determined using a linear color prediction model which determines an estimated colorimetry for a print coverage vector based on a weighted combination of the colorimetry of elements of the print coverage vector, wherein the weighting for each is a probability that the element is to be applied to a print addressable location; and
determine a predicted printed colorimetry of the print coverage vector based on a non-linear color prediction model.
